(19) United States
(12) Patent Application Publication
(10) Pub. No.: US 2022/0049971 A1
(43) Pub. Date: Feb. 17, 2022

(54) METHOD AND SYSTEM FOR PROVIDING PUBLIC TRANSPORT ROUTE GUIDE SERVICE BASED ON VOICE GUIDE

(71) Applicant: NALDA COMPANY LIMITED, Gyeonggi-do (KR)

(72) Inventor: Hyeon Su LEE, Gyeonggi-do (KR)

(73) Assignee: NALDA COMPANY LIMITED, Gyeonggi-do (KR)

(21) Appl. No.: 17/274,620

(22) PCT Filed: Sep. 10, 2019
(86) PCT No.: PCT/KR2019/011768

§ 371 Date: Mar. 9, 2021

(30) Foreign Application Priority Data
Sep. 12, 2018 (KR) 10-2018-0108639

(51) Int. Cl. G01C 21/36; G06Q 50/26; G06F 16/29; G06F 16/9537; G10L 17/22; G06K 9/00

(52) U.S. Cl. CPC G01C 21/3629; G06Q 50/265; G06F 16/29; G06K 7/1095; G10L 17/22; G06K 9/00671; G06K 9/00288; G06F 16/9537

(57) ABSTRACT

A method for providing a public transport route guide service based on voice is provided, the method comprising the steps of: a method for providing a public transport route guide service based on voice guide, scanning or reading a first public transport information guide terminal that outputs a route information searched by a user's voice and an identification code corresponding to the route information, collecting data corresponding to the identification code and outputting a route guide in sound or voice based on a real-time location of the user terminal, outputting transfer information before reaching to a transfer stop if transfer information exists in the route guide, calling and controlling a second public transport information guide terminal located at the transfer stop to output transfer information; and starting route guide based on the real-time location of the user terminal and closing route guide when reaching to a destination.

### TECHNICAL FIELD

The present invention relates to a method for providing a public transport route guide service based on voice guide, which provides a method capable of providing a guide for not only a route, but also a whole course including a transfer and a destination stop based on human voice.

### BACKGROUND

Spatial segregation between supply and demand regions is intensified year by year, therefore, the ability to overcome the spatial segregation between major service locations and residential areas, i.e., mobility between regions, is one of the most important factors ensuring urban residents to lead basic daily life in cities. Mobility for the socioeconomic life is the minimum right for the survival of urban residents, which has been guaranteed to a certain extent through the supply of public transport services in Korea. It is reported that the reliance on public transport for commuting citizens in Seoul, Korea occupies high proportion of 48.7%, and that the competitiveness of Seoul in public transport compared to cities in other countries is also high.

Many methods of guide service on the public transport route have been developed and disclosed to use the public transport efficiently. Among the methods, Korean Patent Publication Laid-open No. 2013-0115434 (published on Oct. 22, 2013) discloses a method which extracts and provides guide services available at the transfer points on the public transport route and other useful information to the users on the main street corners along the user's route, as well as providing advertisements for marketing that would be carried out more efficiently.

Recent studies point out that the public transport infrastructure supply policy conducted by the government so far has been carried out with an emphasis on the value of efficiency only, and that the concept of fairness should be emphasized too for the supply of the public transport service. However, in fact, the research on the fairness of public transport services mostly deal with the accessibility to public transport service facilities in a region, and studies on mobility between regions are not sufficient. This means that the research did not consider the fairness for urban residents in terms of mobility in depth, which is an important factor for normal living.

According to an embodiment of the present invention, even an infant or an elderly person who has difficulty in using a terminal, such as a smartphone, would be provided with a route guide via voice support, thereby mobility between regions of the underprivileged in public transport can be improved. The embodiment does not aims guiding the route only but providing a public transport route guide service based on voice guide, which can eliminate the possibility that the public transport cannot be used properly because of not knowing the transfer route or destination. The embodiment informs transfer stop and destination based on real-time location information and guide the course to the transfer stop. However, the technical problems to be solved by the present embodiment is not limited to the described above, but other technical problems may exist.

### SUMMARY

In order to achieve above technical problems, an embodiment according to the present invention provides a method of providing a route guide service executed in a user terminal comprising the steps of scanning or reading a first public transport information guide terminal that outputs a route information searched by a user's voice and an identification code corresponding to the route information, collecting data corresponding to the identification code and outputting a route guide in sound or voice based on a real-time location of the user terminal, outputting transfer information before reaching a transfer stop if transfer information exists in the route guide, making a call and controlling a second public transport information guide terminal located at the transfer stop to output transfer information; and starting a route guide based on the real-time location of the user terminal and closing the route guide when reaching a destination.

Another embodiment according to the present invention provides a route guide service providing system comprising a public transport information terminal which recognizes a user's voice and processes it to natural language, converts the natural language to machine language using a chatbot agent, searches for the corresponding result, outputs the result to a screen or a speaker, and, when a call signal is received, turns RGB lamp lights on or makes the same flicker, shoots and monitors the front in real-time by a camera, outputs an identification code on the screen for route guide information, and when the screen is scanned, transfer the route data to the user who scanned, and a user terminal which reads or scans the identification code displayed on the screen of the public transport information guide terminal to receive route information, updates the current location in real time to display the current location in the route information, and, before reaching a destination included in the route, outputs arrival schedule information a preset number of stops before the destination.

According to any one of the above-described problem-solving means of the present invention, even an infant or an elderly person who has difficulty in using a smart terminal, such as a smartphone, would be provided with a route guide via voice support, thereby mobility between regions of the underprivileged in public transport can be improved. The present invention does not aims guiding the route only but providing a public transport route guide service based on voice guide, which can eliminate the possibility that the public transport cannot be used properly because of not knowing the transfer route or destination.

### BRIEF DESCRIPTION OF THE DRAWINGS

FIG. 1 is a diagram for explaining a system for providing a public transport route guide service based on voice guide according to an embodiment of the present invention.

FIG. 2 is a block diagram for explaining a user terminal included in the system of FIG. 1.

FIGS. 3 and 4 are diagrams for explaining embodiment of a public transport route guide service based on voice guide according to the present invention.

FIGS. 5 to 8 are diagrams for explaining other embodiment of a public transport route guide service based on voice guide according to the present invention.

FIG. 9 is a flow chart for explaining an embodiment of a public transport route guide service based on voice guide according to the present invention.

### DETAILED DESCRIPTION

Hereinafter, embodiments of the present invention will be described in detail with reference to the accompanying drawings so that a person who has ordinary skill in the art can easily implement the present invention. However, the present invention may be implemented in various forms and is not limited to the embodiments described herein. In the drawings, parts irrelevant to the description are omitted for clarity, and similar reference numerals are assigned to similar parts throughout the specification.

In the specification, when a part is said to be “connected” with another part, this includes not only “directly connected” but also “electrically connected” with another element therebetween. In addition, when a part “comprises” a certain element, unless specifically stated to the contrary, that does not exclude any other elements but includes. It should be understood that it does not preclude the presence or addition of any other feature, number, step, operation, component, part, or combination thereof.

Throughout the specification, the terms “about,” and “substantially” are used at or close to the numerical value when manufacturing and material tolerances specific to the stated meaning are presented and are used to provide an understanding of the present invention, and to help for understanding the present invention, accurate or absolute figures are used to prevent unfair use of the stated disclosure by unscrupulous infringers. Throughout the specification of the present invention, the term “step (to)˜” or “step of—” does not mean “step for˜.”

In the present specification, the term “unit” includes a unit realized by hardware, a unit realized by software, and a unit realized using both. Furthermore, a unit may be realized by using two or more hardware, or two or more units may be realized by a hardware.

In this specification, some of the operations or functions described as being performed by the terminal, device, or device may be performed in a server connected to the terminal, device, or device. Likewise, some of the operations or functions described as being performed by the server may also be performed by a terminal, device, or device connected to the server.

In this specification, some of the operations or functions described as mapping or matching with a terminal means mapping or matching the unique number of the terminal or the identification information of individuals, which is the identification data of the terminal.

Hereinafter, the present invention will be described in detail with reference to the accompanying drawings.

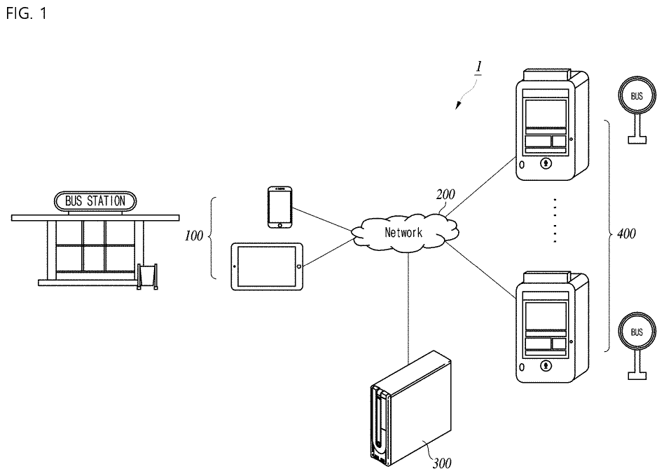

FIG. 1 is a diagram for explaining a system to provide a public transport route guide service based on voice guide according to an embodiment of the present invention. Referring to FIG. 1, the voice-guide based public transport route guide service providing system 1 includes at least one user terminal 100, a route guide service server 300, and at least one public transport information guide terminal 400. However, since the public transport route guide service system based on voice guide 1 of FIG. 1 is only an embodiment of the present invention, the present invention is not limited to the embodiment of FIG. 1.

The components in FIG. 1 are generally connected through a network 200. For example, as shown in FIG. 1, at least one user terminal 100 may be connected to the route guide service server 300 and the public transport information guide terminal 400 through the network 200. The route guide service server 300 may be connected to at least one user terminal 100 and at least one public transport information guide terminal 400 through the network 200 too. Also, at least one public transport information guide terminal 400 may be connected to the route guide service server 300 and the user terminal 100 through the network 200.

Here, the network refers to a connection structure in which information can be exchanged between nodes such as a plurality of terminals and servers. Examples of such network include RF, 3GPP (3rd Generation Partnership Project) network, and LTE (Long Term Evolution) network, 5GPP (5th Generation Partnership Project) network, WIMAX (World Interoperability for Microwave Access) network, Internet, LAN (Local Area Network), Wireless LAN (Wireless Local Area Network), WAN (Wide Area Network) , PAN (Personal Area Network), Bluetooth network, NFC network, satellite broadcasting network, analog broadcasting network, DMB (Digital Multimedia Broadcasting) network, and the like, but are not limited thereto.

In the following, the term ‘at least one’ is defined as a term including the singular number and the plural number, and even if the term ‘at least one’ does not exist, it is apparent that each component may exist in the singular or plural and may mean the singular or plural. In addition, it will be possible to change, according to an embodiment, that each component may be provided in a singular or plural.

The at least one user terminal 100 may be a terminal that outputs a public transport route guide using a web page, an app page, a program, or an application related to the public transport route guide service based on voice-guide. The at least one user terminal 100 may be a terminal that outputs data for guiding not only a public transport route, but also any route indoors or outdoors. In addition, the at least one user terminal 100 may be a terminal that transmits a call signal to the public transport information guide terminal 400 to receive transfer information and that receives route data read manually or automatically from the public transport information guide terminal 400 to output route guide information. And the at least one user terminal 100 may be a terminal that compares the current location with a transfer point or destination, and outputs an alarm when the current location is near the transfer point or destination. Further, the at least one user terminal 100 may be a terminal that receives and outputs information on public transport or route to be transferred after arriving at a transfer location from the public transport information guide terminal 400 located at the transfer location. Further, the at least one user terminal 100 may be a terminal that processes natural language based on voice or chatbot and outputs the result in natural language.

The at least one user terminal 100 may be implemented as a computer that can access remote servers or terminals through a network. And the computer may include, for example, a navigation system, a notebook equipped with a web browser, a desktop, a laptop, and the like. In this case, the at least one user terminal 100 may be implemented as a terminal capable of accessing remote servers or terminals through a network. The at least one user terminal 100 comprises, for example, a wireless communication device that can guarantee the portability and the mobility, and may include all types of handheld communication devices such as a navigation system, PCS (Personal Communication System), GSM (Global System for Mobile communications), PDC (Personal Digital Cellular), PHS (Personal Handy-phone System), PDA (Personal Digital Assistant), IMT (International Mobile Telecommunication)-2000, CDMA (Code Division Multiple Access)-2000, W-CDMA (W-Code Division Multiple Access), Wibro (Wireless Broadband Internet) terminals, smartphones, smart pads, and tablet PCs.

The route guide service server 300 may be a server that provides a voice guide-based public transport route guide service web page, app page, program, or application. The route guide service server 300 may be configured only when a service process cannot be performed by the user terminal 100 and the public transport information guide terminal 400 due to a lack of computing resources or networking resources, so the route guide service server 300 is not indispensable, though the configuration of the server is included. The route guide service server 300 may be a server that can learn questions and answers based on big data and updates a plurality of public transport information guide terminals 400 based the same. When images captured by the public transport information guide terminal 400 are collected, the route guide service server 300 stores the images to be mapped to each location identification code, and, when the user terminal 100 requests a search, tracks an object by comparing the captured image with the object requested for search, and transmits the result to the user terminal 100. When the user terminal 100 receives route guide using augmented reality, the route guide service server 300 displays an image or icon that should be overlaid on a camera screen based on the location of the user terminal 100. To this end, the route guide service server 300 builds big data using at least one information providing server 500 and previously stored history log data and learns how to classify and to cluster the big data through collecting, pre-processing, and analyzing. Also, the route guide service server 300, to extract an identifier from a motion picture data or an image data which is atypical data, performs data learning using a deep learning artificial neural network algorithm for tagging the identifier from the motion picture data and the image data. The route guide service server 300 may be a server that tags or extracts an identifier from a motion picture or an image that are input according to a learning result.

The route guide service server 300 may be implemented as a computer capable of accessing a remote server or terminal through a network, and the computer may include, for example, a navigation system, a notebook equipped with a web browser, a desktop, a laptop, and the like.

The at least one public transport information guide terminal 400 may be a terminal located at a public transport stop that outputs route information using a web page, an app page, a program, or an application related to a voice guide-based public transport route guide service. However, as described above, the location can be changed according to the purpose or use. When a user makes a query by voice, the at least one public transport information guide terminal 400 outputs a result as a voice or a screen after the voice recognition process and transmits the data to the user terminal 100 to be recognized automatically or manually. When a call including transfer information is made from the user terminal 100, the public transport information guide terminal 400 receives the call signal and makes LED, LCD, lamp, etc. blink or control the color. The at least one public transport information guide terminal 400 may be a terminal that inserts and transmits a location tag of an image taken by a camera to the route guide service server 300. Other functions and configurations are described in Korean Patent Registration No. 10-1768210 in the name of the present applicant (published on Aug. 16, 2017), thus detailed description for the same will be omitted.

The at least one public transport information guide terminal 400 may be implemented as a computer that can access remote servers or terminals through a network. And the computer may include, for example, a navigation system, a notebook equipped with a web browser, a desktop, a laptop, and the like. In this case, the at least one public transport information guide terminal 400 may be implemented as a terminal capable of accessing remote servers or terminals through a network. The at least one public transport information guide terminal 400 comprises, for example, a wireless communication device that can guarantee the portability and the mobility, and may include all types of handheld communication devices such as navigation, PCS (Personal Communication System), GSM (Global System for Mobile communications), PDC (Personal Digital Cellular), PHS (Personal Handy-phone System), PDA (Personal Digital Assistant), IMT (International Mobile Telecommunication)-2000, CDMA (Code Division Multiple Access)-2000, W-CDMA (W-Code Division Multiple Access), Wibro (Wireless Broadband Internet) terminals, smartphones, smart pads, and tablet PCs.

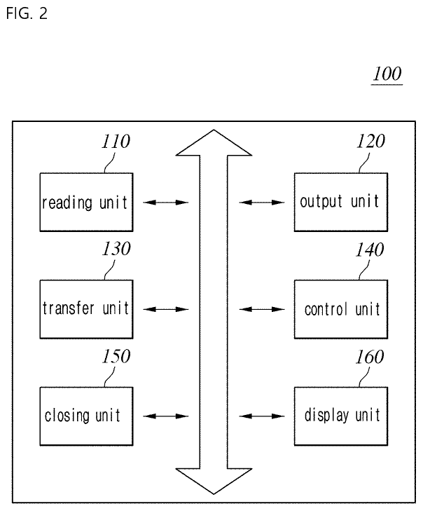

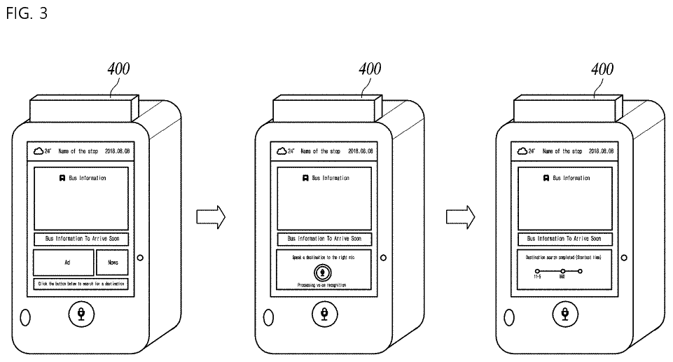

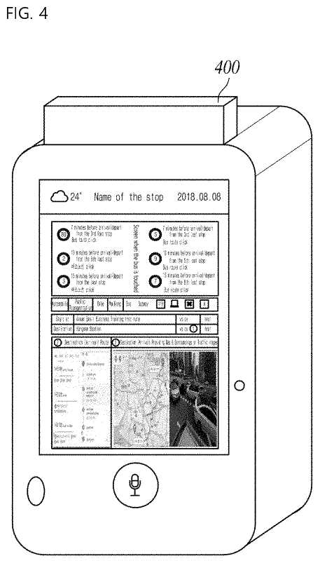

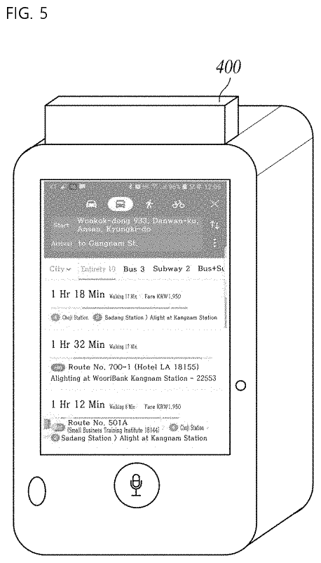

FIG. 2 is a block diagram illustrating a user terminal included in the system of FIG. 1, and FIGS. 3 and 4 are diagrams explaining an embodiment in which a public transport route guide service based on voice-guide is implemented according to an embodiment of the present invention. FIGS. 5 to 8 are diagrams for explaining the other embodiment in which a voice guide-based public transport route guide service is implemented according to an embodiment of the present invention.

Referring to FIG. 2, the user terminal 100 may include a reading unit 110, an output unit 120, a transfer unit 130, a control unit 140, a closing unit 150, and a display unit 160.

When the route guide service server 300 according to an embodiment of the present invention or another server (not shown) that coupled therewith transmits a voice guide-based public transport route guide service application, program, app page, or web page, etc., to the at least one user terminal 100 and/or the at least one public transport information guide terminal 400, the at least one user terminal 100 and the at least one public transport information guide terminal 400 may install or open the information service application, programs, app pages, or web pages. A service program may be run in a user terminal 100 and at in a public transport information guide terminal 400 by using a script run in a web browser. Here, the web browser is a program that allows to use the web (WWW: world wide web) service, which means a program that receives and displays hypertext described in HTML (hyper text mark-up language), such as, Netscape, Explorer, and Chrome. The application refers to an application in the terminal, and includes, for example, an app that can be executed on a mobile terminal (smart phone).

Referring to FIG. 2, the reading unit 110 may scan or read a first public transport information guide terminal 400 which outputs a route information and an identification code corresponding to the route information retrieved by a user's voice. The reading unit 110 may receive data manually or automatically input from the first public transport information guide terminal 400, for example, by scanning manually a QR code with the user terminal 100, and by inputting through automatic recognition of the location-based switching point NODE DATA.

The output unit 120 collects data corresponding to the identification code and outputs a route guide as sound or voice based on a real-time location of the user terminal 100. Here, the output type is to indicate the currently updated location of the user terminal 100 on a route of a map or a route node in real time, but not limited thereto. It would be obvious to include visual output through a screen in addition to audio output through speakers.

The transfer unit 130 outputs transfer information before reaching to a transfer stop when any transfer information exists in the route included in the route guide. The term “before reaching to a transfer stop” means several stops before or even several meters before, which depends according to embodiments, and not limited to the above described.

The control unit 130 calls and controls the second public transport information guide terminal 400 located at the transfer stop to output the transfer information. Then, the second public transport information guide terminal 400 that received the call blinks or changes the colors of the RGB lamps to be noticed by the user, and the user can recognize the second public transport information guide terminal 400. In addition, the second public transport information terminal 400 informs the user of the number or line of a bus or a subway to transfer, the arrival time, and the color and the design of the bus to come. If the place is not the correct transfer stop, the user terminal 100 informs the user of the route on augmented reality, virtual reality, or a map, and guides the route in consideration of the walking speed.

The closing unit 150 terminates route guide when reaching to a destination based on real-time location of the user terminal 100. If there is a plurality of transfer information, the step of outputting transfer information and the step of outputting transfer information by the control unit 140 may be repeated as many times as the number of transfer information by the transfer unit 130 until the user reaches the destination.

After the step of collecting data corresponding to the identification code from the output unit 120 and outputting the route guide by sound or voice based on the real-time location of the user terminal 100, if there is no more transfer information in the route, the display unit 160 displays the location of the stop corresponding to the destination and the current location corresponding to the real-time location of the user terminal 100. The display unit 160 also outputs arrival schedule information before a preset number of stops from the destination stop, and outputs alighting information when the user reaches the destination stop. The arrival schedule information may include information on how many stops or meters are left from the destination, and the alighting information may include information that the user reaches a transfer point or a destination and should get off right away.

In summary, the user terminal 100 reads or scans the identification code displayed on the screen of the public transport information guide terminal 400 to receive route information, updates the current location in real time to display the current location in the route information, and, before reaching to the destination included in the route, outputs arrival schedule information a preset number of stops before the destination. The public transport information terminal 400 recognizes the user's voice and processes it as natural language, converts it to machine language by a chatbot agent, searches for the corresponding result and outputs the result to the screen or speaker. When a call signal is received, the public transport information terminal 400 turns the RGB lamp lights on or blinks the same, shoots and monitors the front in real-time by the camera, and outputs the identification code on the screen for route guide information. When the screen is scanned by the user, the public transport information terminal 400 can transmit the route date to the user. Then, the user terminal 100 may output the route information by overlaying it on the AR screen after turning the camera on.

The route guide service server 300 may be coupled with the public transport information guide terminal 400, builds up query data input from the public transport information guide terminal 400 as big data, and collects the image taken from the public transport information guide terminal 400 on the location-base. When a request to search for the captured object is received from the user terminal 100, the subject included in the captured image is compared with an object stored in the big data by facial recognition, and the result can be sent to the requestor.

In order to build up big data, the route guide service server 300 refines unstructured data, structured data, and semi-structured data included in stored raw data, pre-processes, for example, classifies metadata, and analyzes, for example, mines the pre-processed data. The route guide service server 300 visualizes and outputs the analyzed data. As a data mining, classification which predicts a class of new data or clustering which groups data based on similarity without class information can be performed by learning a training data set with a known class with searching for an intrinsic relationship between preprocessed data. There may be various other mining methods, and the mining can be performed differently according to the types of big data to be built up and stored or the types of queries to be requested later. The big data built up in this way can be verified through deep learning of artificial neural networks or machine learning. Artificial neural network deep learning may be useful when analyzing image data.

A CNN (Convolutional neural network) structure can be used as an artificial neural network since the CNN is a network structure using a convolutional layer, which is suitable for image processing, and can classify images based on the features in the input image data. Text mining is a technology that aims to extract and process useful information from non/semi-structured text data based on natural language processing technology. By the text mining technology, meaningful information can be extracted from a vast bundle of texts, linkages with other information can be grasped, and a category of text can be found, or better results can be obtained compared to a simple information search. By using text mining, in the route guide service according to an embodiment of the present invention, large-volume language resources with statistical and regular algorithms may be used to analyze an identifier or natural language that is input as a query and to discover hidden information therein. In addition, cluster analysis can be used to finally discover groups of similar characteristics while combining sieves with similar characteristics.

Hereinafter, an operational procedure according to the configuration of the route guide service server of FIG. 2 will be described in detail with reference to FIGS. 3 to 8 as an embodiment. However, it would be apparent that the embodiment is only one of various embodiments of the present invention and is not limited thereto.

Referring to FIG. 3, it is assumed that a user wants to go to a destination, for example, Seoul Station from Anyang City Hall, as a starting location, by bus. First, the user goes to a public transport information terminal 400, for example, in a kiosk and speaks natural language about how to get to Seoul Station, then the public transport information terminal 400 of which current location is fixed and stored searches bus routes from the current location to Seoul Station and prints the result. The user scans a QR code output on the screen of the public transport information guide terminal 400 or receives route information by automatic recognition of the location-based turning point NODE DATA with the user terminal 100. After that, the user checks up the user terminal 100 or the public transport information terminal 400 about when the next bus to come.

When the user onboard the bus moves, the user terminal 100 detects the speed of the bus and tracks the current location of the bus (the user) on the route and displays. Assuming the user has to transfer once, the user terminal 100 sounds an alarm at the transfer location, and even if the user falls asleep or has no geographical knowledge, the user terminal 100 make the user know when and where to get off. When the user arrives at the transfer stop and leaves the bus, the user terminal 100 calls the public transport information guide terminal 400 located at the current transfer stop. Then the public transport information guide terminal 400 which received the call outputs information for the bus to which the user should take on for transfer, for example, the bus route number, and when the bus will come, so that the user can transfer to the next bus safely and accurately.

When the next bus arrives and the user takes on the bus, the user terminal 100 senses the speed of the bus, determines that the user is on the bus again and restarts route guide. Likewise, the user terminal 100 updates its GPS signal in real-time to indicate its location on a route, as well as output information regarding how many stops to go and when to get off at the destination. Assuming that the user has to go to a certain building, the user terminal 100 not only guides the public transport, but also continues to perform a navigational function tailored to the walking speed of the user even after getting off the bus. It is described above that the augmented reality enables the user to find the way better.

FIG. 4 illustrates an embodiment of a screen of the public transport information guide terminal 400. The public transport information guide terminal 400 may guide routes according to the various types of public transport from a starting point to a destination. This will be described in detail with reference to FIGS. 5 to 8.

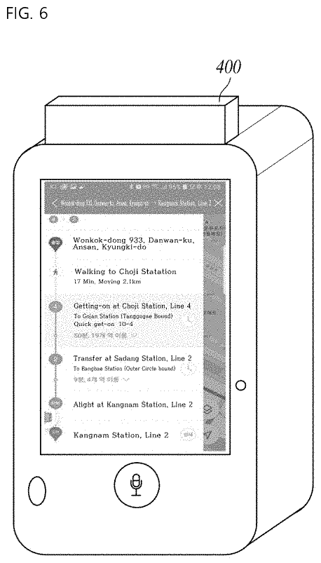

FIGS. 5 and 6 illustrate a public transport information guide terminal 400 that outputs a route, guides the route by voice, and supports voice guide for queries. The queries are, for example, “Gangnam Station,” “Go to Gangnam Station,” “Going to Gangnam Station by bus,” “How to get to Gangnam Station,” “How do I go to Gangnam Station,” “I want to go to Gangnam Station,” “I want to know how to go to Gangnam Station,” “How to get to Gangnam Station by public transport,” “Tell me how to get to Gangnam Station by public transport,” “Tell me how to take the bus to Gangnam Station,” “Tell me how to take the subway to Gangnam Station,” “Which line do I have to get to Gangnam Station,” etc., but queries may be added according to the result of converting the queries into the big data, therefore, it is obvious that it is not limited to the above queries.

Accordingly, the public transport information terminal 400 informs the answer by voice (as well as by the screen) and repeats the answer when the query is received again by voice. A speech recognition algorithm performs pre-processing and feature extraction. Since speech signal includes not only the verbal meaning, but also various information such as noise, reverberation, and characteristics of individual speakers, various pre-processing techniques are used for extracting only the verbal meaning from the speech signal. For example, direction of arrival estimation technology, speech enhancement technology using beamforming, and blind source separation (BSS) technologies are used in the preprocessing process.

For the speech recognition, a sequence of acoustic feature vectors should be extracted from the pre-processed speech signal. In general, short-time Fourier transform (STFT) is performed on a speech signal every 10 ms in 25 ms intervals, and then energies of each band are obtained through a mel-scale filterbank that imitates human hearing model. DCT (discrete cosine transform) is performed on the log values of those energies, and finally MFCCs (mel frequency cepstral coefficients) are obtained. As a feature vector composed of MFCCs, usually, a feature vector of the 39th order obtained by adding the basic coefficients of the 13th order and the first and second derivatives of the coefficients is used. Other speech features include features through perceptual linear predictive (PLP) analysis and linear predictive cepstral coefficients (LPC) features. Feature extraction methods through learning can also be used, including feature-space minimum phone error (fMPE), which is discriminative training in a feature space, and feature extraction method using a neural network (NN). Post-processing methods for feature vectors include speaker-based cepstral mean and variance normalization (CMVN) and sentence-level CMS (cepstral mean subtraction). Features that are strong to noise are extracted by performing principal component analysis (PCA) or linear discriminant analysis (LDA) on the extracted feature vectors.

Among the acoustic models, the Hidden Markov model (hereinafter, HMM) is a model which is frequently used to express temporal or spatial sequence data such as voice, image, video, music, and financial data. The model consists of three hidden states, and each hidden state allows only the transition to the right and the transition to itself. Observation vectors occur in each hidden state, and observation vectors are expressed using a Gaussian mixture model (GMM). For learning of the acoustic model, the parameters of the HMM, which is an acoustic model for speech recognition, should be estimated from the learning data. A basic method for estimating parameters of HMM is maximum likelihood estimation for training data. However, since the training data lacks some information included in the likelihood function of HMM-GMM, EM algorithm is mainly used to solve this problem. EM algorithm is an algorithm that performs E-step and M-step alternately, in E-step, the expected value of the objective function is defined by estimating the posterior probability for unknown variables, and in M-step, the parameter which maximize the expected value of the objective function is estimated. Since EM algorithm is an algorithm which finds out the local maximum value, the obtained value may not be the maximum value, therefore, setting a proper initial value is one of important issues.

After features have been extracted from the speech signal and the acoustic model has been learned, an algorithm which recognizes unknown speech signal will be explained below. When an observed signal X is given, it is needed to estimate the hidden state series of each HMM and calculate the likelihood to recognize using HMM. For this, the Viterbi algorithm is generally used. The Viterbi score for the i-th state of the t-th observation signal is defined as follows. The meaning of this score is the product of multiplication of the maximum value among the values that multiplication of the Viterbi score to j^{th} state of t−1^{th} observation signal for all j and the probability of transition from s_i to s_j with the probability that t^{th} observation signal occurring in the i^{th} state. For all the Viterbi score states, after sequentially calculating from t=1, finding the state where the Viterbi score reaches the maximum at t=T, and going back to the past state that reached that state, make it possible to calculate the hidden state sequence and its likelihood. If the same task for all HMMs is performed and a HMM with the maximum likelihood is found, the recognition result for the observed signal can be obtained.

Furthermore, advanced voice recognition technology can be used, the first is discriminative learning. In machine learning, discrimination learning refers to a technique that maximizes the distance between different models. While the above-mentioned maximum likelihood estimation is a technique for learning a model to faithfully generate one's own data, discrimination learning is a technique that maximizes the distance between itself and other models, that is, guarantees optimality for discrimination performance. In general, discriminative learning shows better recognition performance than the maximum likelihood estimation information in speech recognition systems. After all, discrimination learning in speech recognition means learning an acoustic model to minimize the word error rate (WER). However, since it is difficult to directly learn the acoustic model to minimize WER, minimizing the classification error rate (MCE) approximating WER is learned. MCE estimation is a method derived from the Bayes' decision rule and may have good performance compared to the maximum likelihood estimation information.

Furthermore, the Semi-Markov model (SMM) can be used, which is a model that simultaneously performs dividing phonemes of sequential speech data as input (when the basic unit corresponding to a node is a phoneme in the Markov model) and label prediction and considers the statistical correlation between all observation values within a phoneme segment using a segment-based Markov structure. HMM cannot accurately model the phoneme length, but SMM can directly model the phoneme length. The problem of SMM inference, namely, if an input speech signal comes in and if the standard of problem for estimating the phoneme (or word) label sequence is MAP, the estimation can be quickly made by using recursion, similar to the Viterbi algorithm used in HMM. It will be apparent that the above-described models for voice recognition and sound recognition are not limited to those described above and can be modified according to various embodiments.

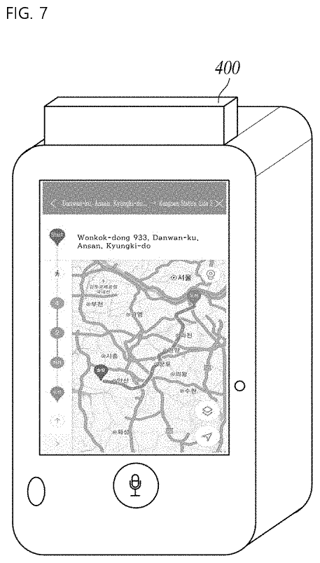

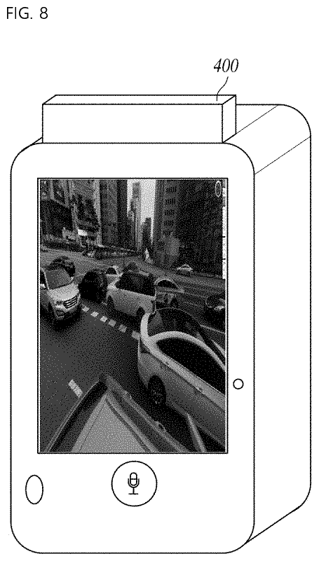

Referring to FIG. 7 and FIG. 8, it is also possible to provide a map showing the entire route or the surrounding situation of the destination. The public transport information guide terminal 400 according to an embodiment of the present invention may be used on information desks, such as in subways, airports, government offices, bank, and department stores, etc. by changing app as well as in the public transport described above. Furthermore, Augmented Reality (AR) technology can be applied to guide the route from the current location to a destination by an AR character, and VR technology also can be applied to simulate the way to the destination, and a face recognition camera technology is applied for finding dementia elderly and dogs either.

Furthermore, the public transport information guide terminal 400 can go to the location of a customer or a consumer who wants the service by combining a voice recognition bank cash dispenser and a robot drive to allow the public transport information guide terminal 400 itself to move by a call, and a voice recognition vending machine to realize, which dispenses products by a voice order, and automatic payment system, for example, such as an easy-pass terminal, can be used to make payment. It will be apparent that the use of it is not limited to those described above.

Since other matters not described for the method of providing the voice guide-based public transport route guide service of FIGS. 2 to 8 are the same as or can be easily inferred from the method of providing the voice guide-based public transport route guide service described in FIG. 16, the description for the same will be omitted.

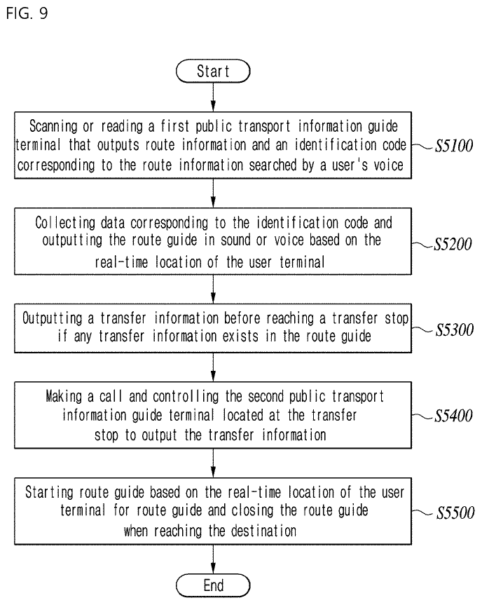

FIG. 9 is a flowchart illustrating a method for providing a public transport route guide service based on voice according to an embodiment of the present invention. Referring to FIG. 9, the user terminal scans or reads the first public transport information guide terminal that outputs route information and the identification code corresponding to the route information searched by a user's voice S5100.

The user terminal collects data corresponding to the identification code and outputs the route guide in sound or voice based on the real-time location of the user terminal S5200, and if there is any transfer information in the route guide, transfer information is output before reaching to a transfer stop S5300.

The user terminal makes a call and controls the second public transport information guide terminal located at the transfer stop to output the transfer information S5400, starts route guide based on the real-time location of the user terminal to guide the route and closes the route guide when reaching to the destination S5500.

The order between the above-described steps S5100 to S5500 is only an example and is not limited thereto. That is, the order of the above-described steps S5100 to S5500 may be freely changed, and some of the steps may be performed at the same time or omitted.

Other matters which are not described in the method for providing the voice guide-based public transport route guide service of FIG. 9 are the same as or can be easily inferred from the method of providing the voice guide-based public transport route guide service described in FIG. 1 to FIG. 8, and the description for the same will be omitted.

The method for providing a public transport route guide service based on voice guide according to an embodiment described with reference to FIG. 9 can be implemented in the form of a recording medium including a computer-executable command such as an application or program module executed by a computer. Computer-readable medium can be any available medium that can be accessed by a computer and includes both volatile and nonvolatile medium as well as removable and non-removable medium. Further, the computer-readable medium may include all kinds of computer storage medium. Computer storage medium includes both volatile and nonvolatile, and removable and non-removable medium implemented in any method or technology for storing information such as computer readable instructions, data structures, program modules or other data.

The method for providing a public transport route guide service based on voice guide according to an embodiment of the present invention described above is provided in an application basically installed in a terminal (this may comprise a program included in a platform or an operating system which are basically installed in the terminal). It may be executed by an application (i.e., a program) which is installed on a master terminal directly by a server which provides the application, such as an application store server, or a web server related to the application or corresponding service by the user. In this sense, the method for providing a public transport route guide service based on voice guide according to an embodiment of the present invention described above is implemented as an application (i.e., a program) installed in a terminal or directly installed by a user and can be recorded on a recording medium.

The above description of the present invention is for illustrative purposes only, and a person having ordinary skill in the art to which the present invention pertains will be able to understand that other specific forms can be easily modified without changing the technical spirit or essential features of the present invention. Therefore, the embodiments described above are illustrative and non-limiting in all respects. For example, each component described as a single type may be implemented in a distributed manner, and likewise, components described as being distributed may also be implemented in a combined form.

The scope of the present invention is set forth in the claims rather than in the detailed description, and all changes or modified forms derived from the meaning and scope of the claims and their equivalent concepts should be interpreted as being included in the scope of the present invention.

What is claimed is:

1. A method for providing a route guide service executed in a user terminal comprising the steps of:
scanning or reading a first public transport information guide terminal that outputs a route information searched by a user's voice and an identification code corresponding to the route information;
collecting data corresponding to the identification code and outputting a route guide in sound or voice based on a real-time location of the user terminal;
outputting transfer information before reaching to a transfer stop if transfer information exists in the route guide;
making a call and controlling a second public transport information guide terminal located at the transfer stop to output transfer information; and
starting a route guide based on the real-time location of the user terminal and closing the route guide when reaching to a destination.

2. The method according to claim 1,
wherein, when a plurality of transfer information exists, outputting the transfer information and controlling the transfer information to be output as many times as the number of transfer information.

3. The method according to claim 1,
after the step of collecting data corresponding to the identification code and outputting a route guide in sound or voice based on a real-time location of the user terminal, if transfer information does not exist in the route guide, further comprising the steps of:
displaying the location of the stop corresponding to the destination and the location of the stop corresponding to the real-time location of the current user terminal;
outputting arrival schedule information before a predetermined number of stops from the destination stop, and
outputting alighting information when the user reaches the destination stop.

4. The method according to claim 1,
wherein the first public transport information guide terminal and the second public transport information guide terminal include a lamp which irradiate an RGB light source in receipt of a call signal from the user terminal.

5. A route guide service providing system comprising:
a public transport information terminal which recognizes a user's voice and processes it as natural language, converts the natural language to machine language using a chatbot agent, searches for the corresponding result, outputs the result to a screen or a speaker, and, when a call signal is received, turns RGB lamp lights on or makes the same flicker, shoots and monitors the front in real-time by a camera, outputs an identification code on the screen for route guide information, and when the screen is scanned, transfer the route data to the user who scanned;
a user terminal which reads or scans the identification code displayed on the screen of the public transport information guide terminal to receive route information, updates the current location in real time to display the current location in the route information, and, before reaching to the destination included in the route, outputs arrival schedule information a preset number of stops before the destination.

6. The system according to claim 5,
wherein the user terminal outputs the route information by overlaying the route information on the AR screen after turning on the camera.

7. The system according to claim 5,
wherein the public transport information guide terminal is coupled with the route guide service server, the route guide service server build query data input from the public transport information guide terminal as big data, and collects the image taken from the public transport information guide terminal on the location-base, and when a request to search for the captured object is received from the user terminal, the subject included in the captured image is compared with an object stored in the big data by facial recognition, and the result is sent to the requestor.
